(19) United States
(12) Patent Application Publication
(10) Pub. No.: US 2014/0375576 A1
(43) Pub. Date: Dec. 25, 2014

(54) FACILITATING TOUCH SCREEN USERS TO SELECT ELEMENTS IN A DENSELY POPULATED DISPLAY

(71) Applicant: Oracle International Corporation, Redwood Shores, CA (US)

(72) Inventors: Puneet Kapahi, New Delhi (IN); Sanjoy Das, Bangalore (IN)

(73) Assignee: Oracle International Corporation, Redwood Shores, CA (US)

(21) Appl. No.: 14/097,260

(22) Filed: Dec. 5, 2013

(30) Foreign Application Priority Data
Jun. 24, 2013 (IN) 2758/CHE/2013

(51) Int. Cl. G06F 3/041; G06F 3/0482; G06F 3/0488

(52) U.S. Cl. CPC G06F 3/0412; G06F 3/0488; G06F 3/0482
USPC 345/173

(57) ABSTRACT

An aspect of the present disclosure facilitates a user of a touch screen to select elements in a densely populated display. In an embodiment, a user taps his finger, potentially covering multiple elements of a display on the touch screen. In response to such a touch, data representing a centre point of tap is received. A zone is formed around the received center, elements within the zone are identified, and an element with the shortest distance to the centre point is determined as the element selected by the user.

### PRIORITY CLAIM

The instant patent application is related to and claims priority from co-pending India Application entitled, “Facilitating Touch Screen Users To Select Elements In A Densely Populated Display”, Application Number: 2758/CHE/2013, filed on: 24 Jun. 2013, First Named Inventor: Puneet Kapahi, which is incorporated in its entirety herewith.

### RELATED APPLICATIONS

The instant patent application is related to the following patent applications, which are all herewith incorporated in their entirety to the extent not inconsistent with the disclosure of the instant patent application:

1. entitled, “Displaying Tooltips To Users Of Touch Screens”, application Number: UNNASSIGNED, filed on: HEREWITH, First Named Inventor: Puneet Kapahi;

2. entitled, “Supporting Navigation On Touch Screens Displaying Elements Organized In A Fixed Number Of Dimensions”, application Number: UNNASSIGNED, filed on: HEREWITH, First Named Inventor: Puneet Kapahi;

3. entitled, “Facilitating Touch Screen Users To Select Elements Identified In A Two Dimensional Space”, application Number: UNNASSIGNED, filed on: HEREWITH, First Named Inventor Puneet Kapahi; and

4. entitled, “Displaying Interactive Charts On Devices With Limited Resources”, application Number: UNNASSIGNED, filed on: HEREWITH, First Named Inventor: Puneet Kapahi.

### BACKGROUND OF THE DISCLOSURE

1. Technical Field

The present disclosure relates to touch screen based systems, and more specifically to facilitating touch screen users to select elements in a densely populated display.

2. Related Art

A touch screen refers to a display screen, which responds to touch operations (e.g., touch/tap, drag, swipe, pinch) of users using one or more fingers, stylus, etc., and facilitates user interfaces with applications based on the operations.

The displays on touch screens often contain various elements. An element refers to a distinct entity (e.g., an icon, hyperlink, graphics element, etc.) that is usually visually demarcated by appropriate visual attribute (e.g., color, border lines) on the display.

Displays are often densely populated with elements. Densely populated displays should be expected to contain multiple elements within a normal area that would be touched by a finger.

Users often wish to select one of the elements in densely populated displays. In one approach, if the point of tap does not fall on precisely the desired element, that desired element is not selected and thus user may be required to touch different areas of the densely populated display to cause selection of the desired displayed element. Often the zoom function is used in combination, to simplify the selection in case of densely populated displays.

It is generally desirable that the selection of a desired element be simplified for users of touch screens.

### BRIEF DESCRIPTION OF THE DRAWINGS

Example embodiments of the present disclosure will be described with reference to the accompanying drawings briefly described below.

FIG. 1 is a block diagram illustrating an example computing system in which several aspects of the present disclosure can be implemented.

FIG. 2 is a flow chart illustrating the manner in which a touch screen based system permits selection of desired elements in an embodiment.

FIGS. 3A-3F represent respective displays on a touch screen illustrating the selection and display of tooltip information

FIG. 4 is a block diagram illustrating the details of a digital processing system in an embodiment.

FIG. 5 is a block diagram illustrating the details of a digital processing system in which various aspects of the present disclosure are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates a user of a touch screen to select elements in a densely populated display. In an embodiment, a user taps his finger, potentially covering multiple elements of a display on the touch screen. In response to such a touch, data representing a centre point of tap is received. A zone is formed around the received center, elements within the zone are identified, and an element with the shortest distance to the centre point is determined as the element selected by the user.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

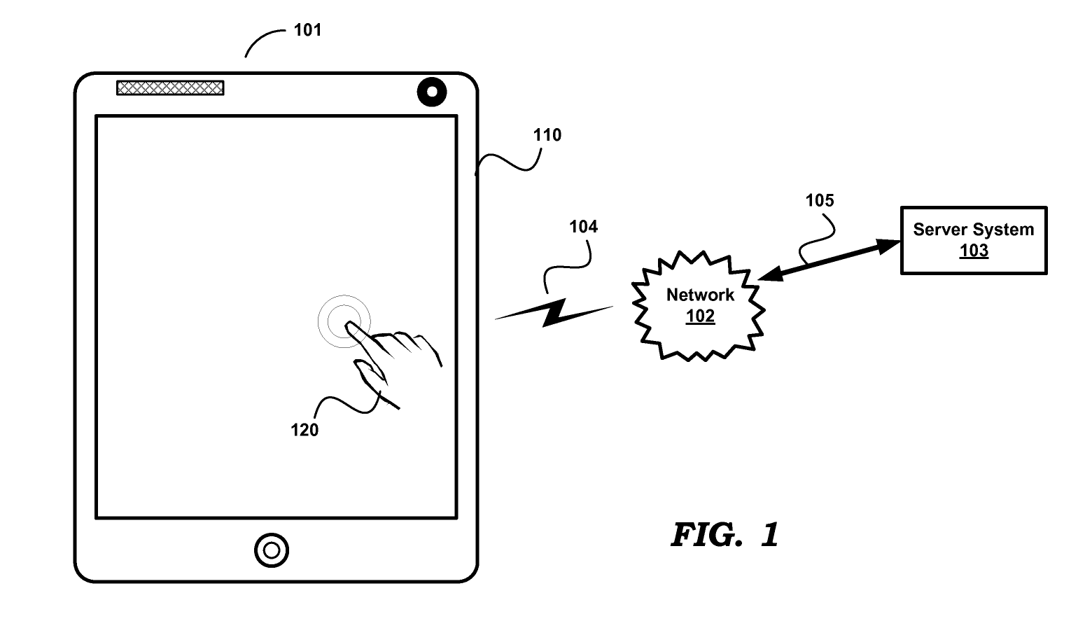

FIG. 1 is a block diagram illustrating the details of an example environment in which several features of the present disclosure can be implemented. The environment is shown containing touch system 101, network 102, and server system 103. Each block is described below in further detail.

Network 102 provides connectivity between touch system 101 and server system 103. Merely for illustration, touch system is shown communicating over wireless path 104, and server system 103 using a wire-based path 105. However, each system 101/103 can have the ability to communicate based on wireless and/or wire-based paths.

Server system 103 implements various applications, that form the basis for interaction with touch system 101. Server system 103 may send data to touch system 101, representing various elements, to facilitate such interaction. Tool tip information corresponding to such elements may also be sent as a part of such data.

Touch system 101 provides user interfaces based on touch screens. Touch system 101 may implement either stand-alone applications or networked applications (i.e., as a client side complementing the server side implementation on server system 103). The networked applications can be as simple as a web browser (with appropriate plug-ins) or a custom application such as a mobile application. Touch system 101 may for example correspond to a personal digital assistant (PDA), a mobile phone, etc. A user is shown performing a touch operation on touch screen 110 using finger 120. As noted above, touch operations can be performed using one or more fingers, stylus, etc.

Touch screen 110 is used for displaying various elements. An element is represented by a portion of a display, visually identifiable as a separate entity in its display context. Examples of elements include various graphical icons, interface elements (buttons, scrollbars, etc.), etc, normally generated by the operation of various user applications (e.g., word processors, spread sheets, custom business applications, etc.) or shared utilities (e.g., operating system).

It may be desirable to facilitate users to select elements in such touch based display screens. Aspects of the present disclosure overcome at least some of the problems/requirements noted above, as described below with examples.

### 3. Facilitating Selection of Elements

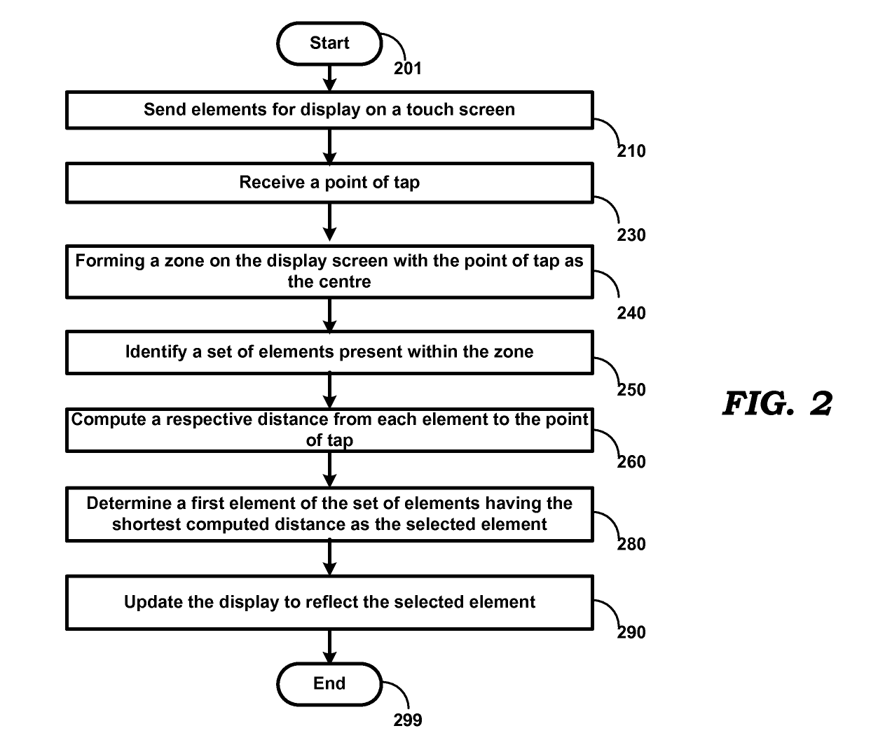

FIG. 2 is a flow chart illustrating the manner in which elements may be selected according to an aspect of the present disclosure. Each step is assumed to be performed in touch system 101 of FIG. 1 for illustration. However, at least some of the steps may be performed in server system 103 (or other systems, not shown) as well.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, elements are sent for display on touch screen 110. The elements may be received from server system 103 or generated locally within touch system 101. The data send for display specifies various attributes of each element such as shape, location, size, etc., as applicable in each case, such that the element can be properly displayed on touch screen 110.

In step 230, a point of tap (tap/touch point) is received. Such a point is received in response to a user having touched a touch area on the touch screen 110, with the touch area potentially covering multiple ones of the displayed elements spanning many points. The tap point may represent a single coordinate point on a graph representing the display area on touch screen 110, with the graph having a coordinate system onto which the display area for each element is mapped. Each pixel on the touch screen 110 display may be viewed as a single point of the coordinate system.

In step 240, a zone is formed with the point of tap as the centre of the zone. The zone can be of any shape, though regular shapes such as squares/rectangles are computationally convenient.

In step 250, a set of elements present within the zone on the touch screen, are identified. Any approach as suitable in corresponding environments may be employed in determining the set of elements. In an embodiment, each element is sent for display on a respective area on the touch screen, wherein a first element is included in the set of elements only if the respective area of the element is within the zone Alternatively, if an element at least partially overlaps with the zone, the element may be included in the set of elements.

In step 260. a respective distance is computed from each of the set of elements to the point of tap. Again, the center of the element may be conveniently considered as a point from which the distance is computed. The distance can thus be a linear distance between the point of tap and the element.

In step 280, a first element of the set of elements having the shortest computed distance as the element is determined. The determination entails comparing the computed distances. The determined element is deemed to be the element selected by the user in the touch area on the touch screen.

In step 290, the display is updated on touch screen 110 to reflect the selected element. For example, the selected element may be highlighted more compared to other elements on the display. The flowchart ends in step 299.

It may be appreciated that the computational complexity in determining the selected element is reduced by using the zone based approach of above.

The above noted approaches and some other features of the present disclosure are illustrated below with respect to various examples.

### 4. Examples

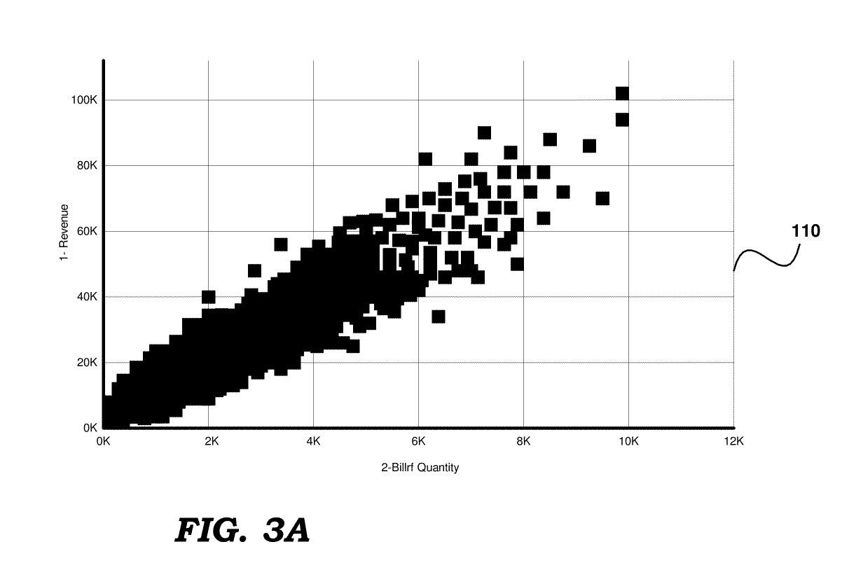

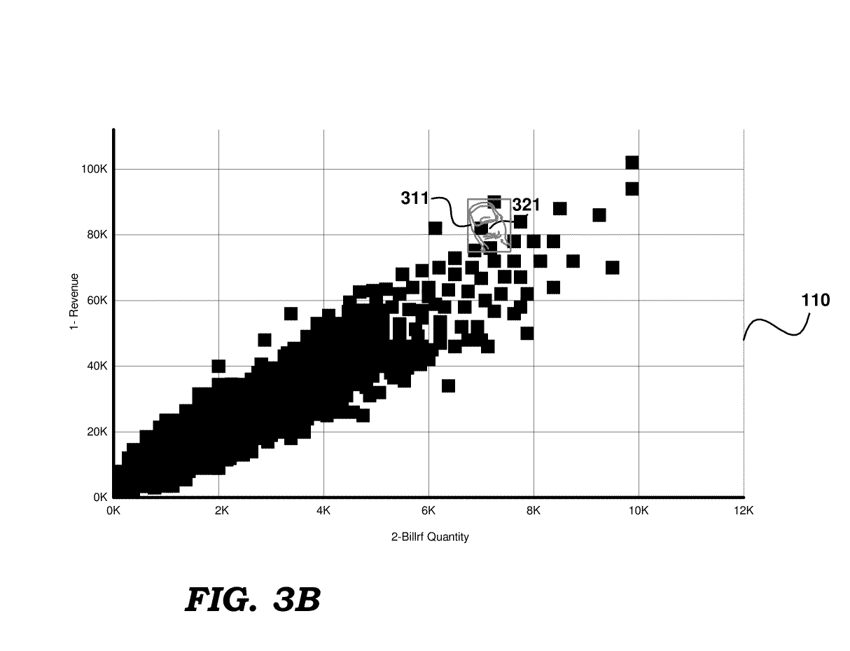

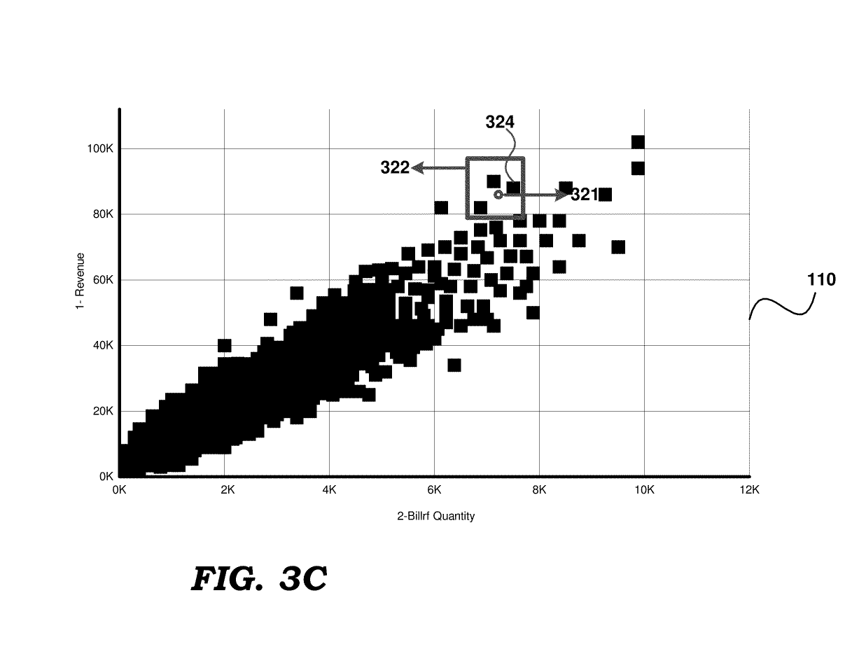

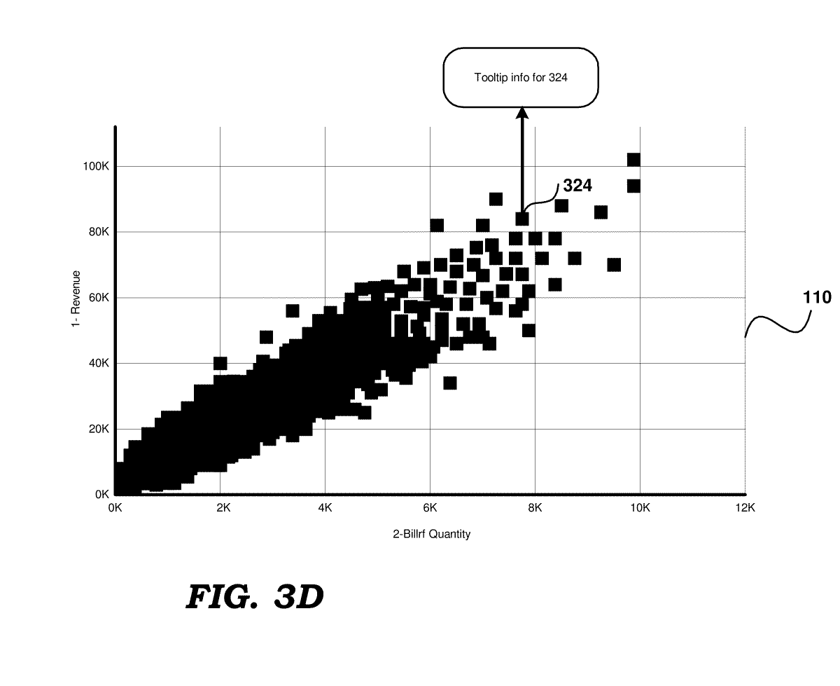

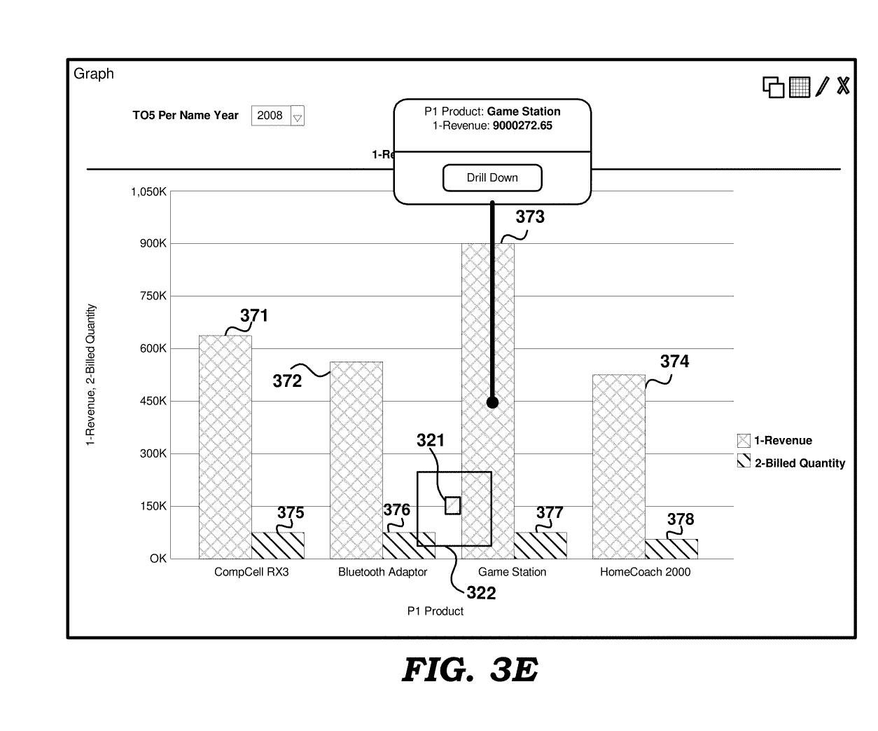

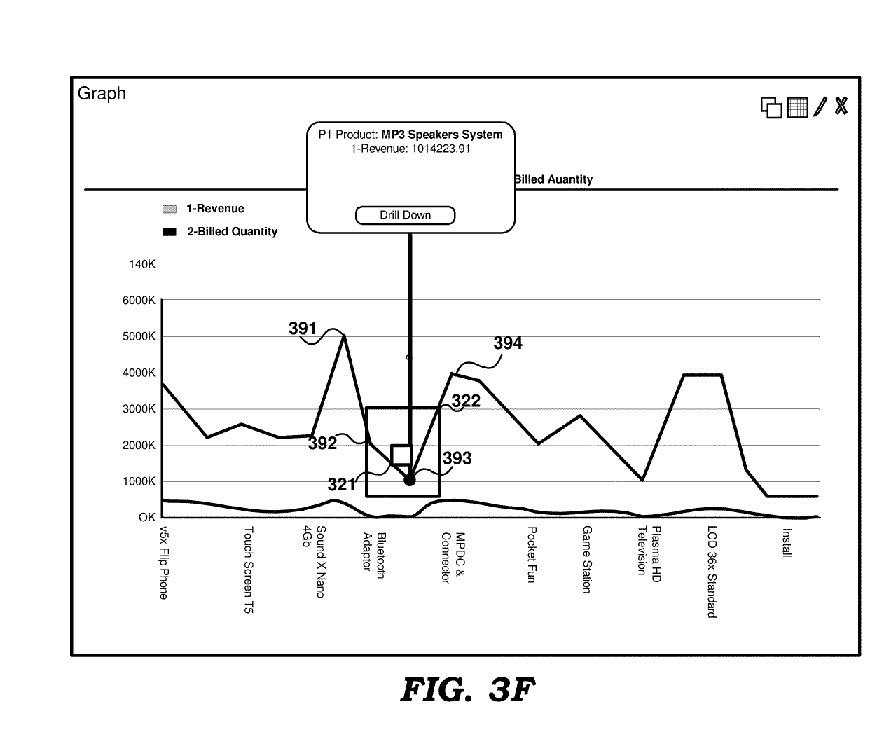

FIGS. 3A-3F represents displays on touch screen 110 at respective time instances, and illustrates some of the features of the present disclosure, as described below.

FIG. 3A depicts the display (on touch screen 110) containing various elements. FIG. 3B depicts an area touched by thumb 311 of a user. Only the outline of thumb is shown for ease of understanding. As may be readily observed, the touched area covers (display area of) several elements. Tap point 321 representing the approximate central point of the touch is shown.

FIG. 3C depicts on a magnified scale, the elements in zone 322 surrounding tap point 321 (represented as a small circle). While zone 322 is shown as a rectangle with the tap point as the centre merely for illustration, the zone can be of alternative shape (but containing the tap point at some point to the middle, or any suitable convention according to the expectations set to the user). In view of the densely characterized display of FIG. 3C (i.e., each element being so small that multiple elements may be covered by a touch area), only those elements that have display area entirely included in (covered by) zone 322 may be considered to be within zone 322 (thereby being candidates to be in the set of elements of step 250).

Element 324 may be observed to be at the shortest distance (compared to other elements having presence in zone 322) to tap point 321, and is accordingly determined to be the element corresponding to the touch operation. In case two elements are equally short distant, one of the elements (e.g., the first one) can be chosen as the selected element.

FIG. 3D depicts display of a tool tip associated with the selected element 324. It should be appreciated other actions (e.g., merely highlighting) may be performed associated with the selected element. It should be appreciated that the zone may be configured to be reasonably large to ensure even elements slightly farther from the touch(ed) area may be selected.

According to another aspect, some level of overlap with zone 322 may qualify an element to be included in the set of elements of step 250, as illustrated with the example of FIG. 3E As shown there, zone 322 based on point of tap 321, does not cover the centre of any of the elements (and consequently does not cover any entire element). In such a case, the distance for each element may be computed to the closest boundary of the element. Thus, element 373, overlapping at least to some extent with zone 322 and having a closer boundary (compared to element 376), is determined to be the selected element. The corresponding tooltip is shown displayed.

FIG. 3F depicts elements 391-394 (each as a single point) connected as a line graph. Zone 322 is shown covering elements 392 and 393. Element 393 is shown as a selected element upon touch at point of tap 321. Though two elements 392 and 393 are covered by zone 322, element 393 is shown as being selected, since element 393 is closer than element 392. Thus, here the intended desired element would be selected even if the tap point does not precisely fall on a small display element.

While the approach illustrated associated with FIGS. 3A-3D is suitable in case of densely populated displays, the approach of FIGS. 3E-3F may be suitable in case of less densely populated displays, where the touch area may not ordinarily cover multiple elements. The Figures also illustrate that the features described above can be used in conjunction with various types of data elements.

The description is continued with respect to the manner in which touch system 101 can be implemented in several embodiments.

### 5. Touch System

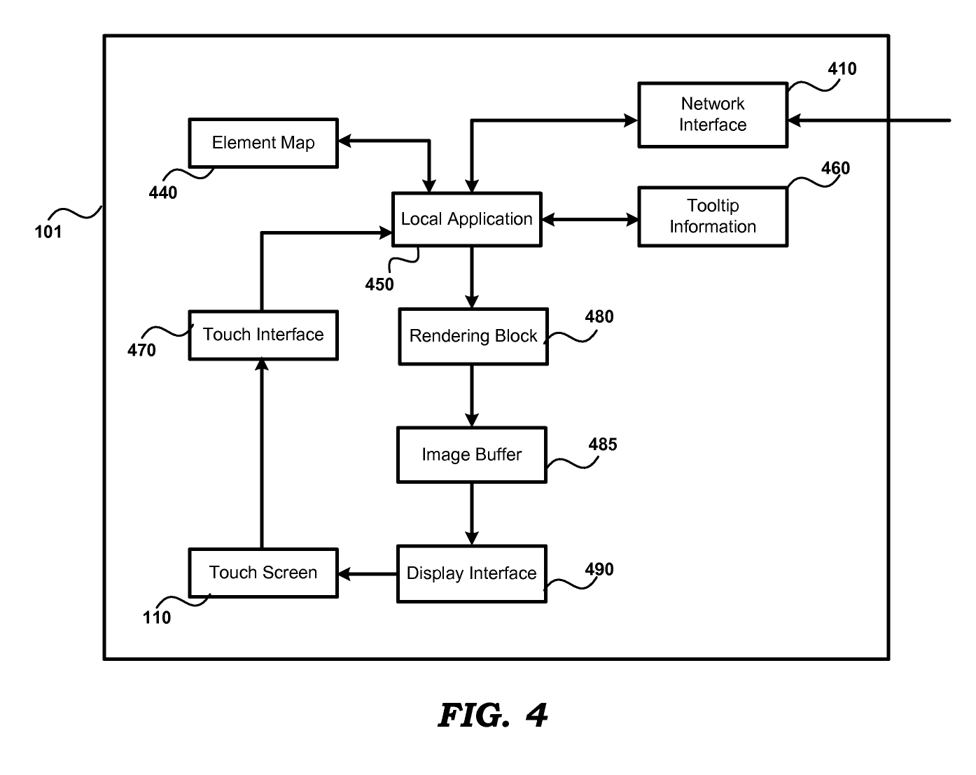

FIG. 4 is a block diagram illustrating the details of touch system 101 in an embodiment. Touch system 101 is shown containing network interface 410, local application 450, tooltip information 460, touch interface 470, rendering block 480, image buffer 485, and display interface 490.

Network interface 410 provides the connectivity with server system 103 to receive data representing various elements and any corresponding tooltip information (for networked applications). The received data is provided to local application 450. In case of stand-alone application such information may be integral to the application being executed.

Touch interface 470 provides information characterizing various touch operations on touch screen 120. For example, the received data may indicate whether a single point/area was touched, multiple were touched simultaneously, and the coordinates of such one or more touches. The data thus received forms the basis for determining whether a user has intended a single touch/tap, drag, pinch, etc., touch operations on touch screen 110. In an embodiment, for each touch/tap operation, coordinate data representing a centre point of the touch (touch point) is provided.

Element map 440 represents the various elements that are displayed on touch screen 110, and the corresponding locations/area covered by the element. Each element may be identified by as simple as a corresponding data point, in case of densely populated displays (e.g., FIGS. 3A-3D). However, data identifying the boundaries (e.g, coordinates representing the lower right and upper left) may be maintained associated with element, such that whether or not an element covers zone 322 may be easily determined (as in FIGS. 3E-3F as well). Tooltip information 460 contains the respective text/information to be provided associated with any/each element that is received from server system 103.

Rendering block 480 may receive the list of elements to be displayed (e.g., characterized by shape and relevant attributes to define the complete image for the element), the corresponding area that each element is to cover on the display screen, etc., and generate a composite image of all the elements. The composite image (e.g., in RGB format) is stored in image buffer 485. Display interface 490 generates display signals which cause the corresponding image to be displayed on touch screen 110. Touch interface 470, rendering block 480, image buffer 485, display interface 490 and touch screen 110 may be implemented in a known way.

Local application 450 represents a client side portion of a networked application (e.g., browser) or a stand-alone application. In case of standalone application, the elements and corresponding information may be formed/created locally upon execution of the corresponding instructions. In case of networked applications, data corresponding to various elements is received from server system 103 via network interface 410. Local application 450 processes the data and populates element map and tooltip information 460 based on the received information.

Based on the elements populated in element map 440, local application 450 then sends a list of elements to rendering block 480, which causes the corresponding display to be generated on touch screen 110 based on the operation of image buffer 485 and display interface 490 described above. At such a first instance upon receipt of the elements on network interface, the display may correspond to that in FIG. 3A.

Upon receiving indication of a touch/tap operation (e.g., with the centre of the touch area received as a parameter value), local application 450 first determines the specific one of the elements in element map 440, which is deemed to be selected. The selection is performed in accordance with FIG. 2 and FIGS. 3B-3E, as described above, using the information maintained in element map 440 as to the display area covered by each element. Thus, an element having presence (at least some overlap) in the zone formed based on the centre of the touch, and with shortest distance to the centre of the zone is determined as the selected element.

The parameters characterizing the zone may be configurable, and stored in a non-volatile memory and retrieved as and when needed. The parameters may specify the size and shape of the zone. The size may be kept large enough to permit elements to be selected, even if the touch/centre point does not fall in the specific area covered by the selected element, as demonstrated above with respect to FIGS. 3E and 3F.

Local application 450 forms another element (or elements) representing the leader line and tooltip box upon selection of an element. The tooltip corresponding to the selected element is retrieved from tooltip information 460, and incorporated into the tooltip box. The leader line is defined to point to the element selected by the user. The list of elements in element map 440 along with the newly formed leader line and tooltip box elements are sent for display. The display now corresponds to that in each of FIGS. 3C-3F. Local application 450 may maintain a local data (for example, in a volatile memory) indicating the details of the selected element (such as, the index of the element in element map 440) and thereafter update the local data based on the subsequent touch operations.

The user may alter the element selection again in accordance with FIG. 2. Once a new/next element is selected, local application 450 retrieves the tooltip information corresponding to the selected element from tooltip information 460, and incorporates the retrieved information into the tooltip box. The local data and display on touch screen 110 are accordingly updated, for the tool tip to map to the newly selected element. Thus, the user may be permitted to select desired elements successively.

It should be further appreciated that the features described above can be implemented in various embodiments as a desired combination of one or more of hardware, software, and firmware. The description is continued with respect to an embodiment in which various features are operative when the software instructions described above are executed.

### 6. Digital Processing System

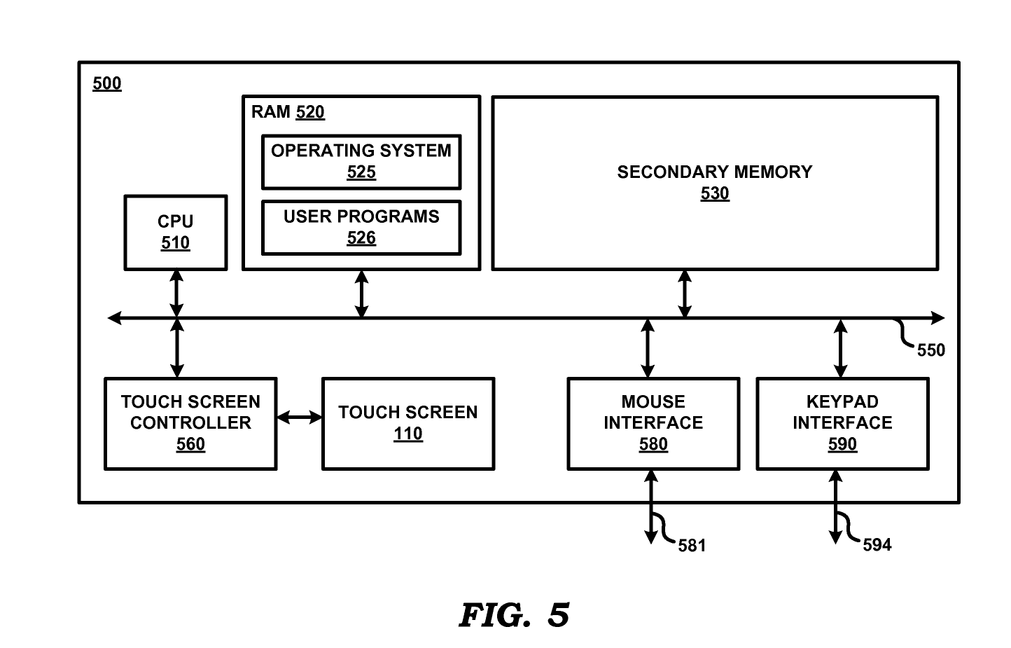

FIG. 5 is a block diagram illustrating the details of an example special purpose computing system in which several aspects of the present disclosure can be implemented. Special purpose computing system (System) 500 (corresponding to touch system 101) is shown containing central processing unit (CPU) 510, random access memory (RAM) 520, secondary memory 530, touch screen controller 560, touch screen 110, mouse interface 580 and keypad interface 590. All the components except touch screen 110 may communicate with each other over communication path 550, which may contain several buses as is well known in the relevant arts.

CPU 540 may execute instructions stored in RAM 520 to provide various features of system 500. Thus, for example, when system 500 corresponds to a PDA, the operation of CPU 540 may enable a user to use one or more of many user applications stored in the PDA and executable by CPU 540. The applications may include, for example, word processors, web browsers, email client, data organizers such as address books, etc. CPU 540 may contain multiple processors, with each processor potentially being designed for a specific task. Alternatively, CPU 540 may contain only a single general-purpose processor. Such combination of one or more processors may be referred to as a processing unit.

RAM 520 may receive instructions from secondary memory 530 using communication path 550. RAM 520 is shown currently containing software instructions constituting shared environment 525 and user programs 526. Shared environment 525 contains utilities shared by user programs 526, and such shared utilities include operating system, device drivers, etc., which provide a (common) run-time environment for execution of user programs/applications. User programs 526 may include applications such as word processing, email client, etc., (or local application 450, including storing of element map 440, configuration data defining the zone, and tooltip information 460) noted above. One or more of user programs 526 may be designed to interact with a user via a graphical user interface (GUI) presented on touch screen 110, described above with respect to FIGS. 3A-3E.

Secondary memory 530 represents a non-transitory machine readable storage medium, and may store data and software instructions (for example, for performing the steps of the flowchart of FIG. 2, described below), which enables system 500 to provide several features in accordance with the present disclosure. Further, secondary memory 530 may store data representing the tooltip information, the information displayed in FIGS. 3A-3E, configuration data representing the zone, etc. The code/instructions stored in secondary memory 530 may either be copied to RAM 520 prior to execution by CPU 540 for higher execution speeds, or may be directly executed by CPU 540.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as secondary memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550 Transmission media can also take the form of acoustic or light waves, such as those generated during radio-wave and infra-red data communications.

Mouse interface 580 enables user-inputs to be provided to system 500 via a mouse (not shown) connected on path 581. Keypad interface 590 is connected to a keypad (not shown) via path 594, and enables user-inputs to be provided to system 500 via a keypad.

Touch screen controller 560 generates display signals (e.g., in RGB format) to cause corresponding text or images (for example, in the form of a GUI) to be displayed on touch screen 110. Touch screen controller 560 receives touch signals generated by touch screen 110, in response to touch/pressure (in general, the touch operations) applied on touch screen 110. Touch screen controller 560 may process such touch signals and generate digital data representing the touch signals.

The generated digital data is passed to appropriate execution entities via the shared environment (operating system) 525. For example, if a touch operation is performed with respect to a visual element controlled by a user application, the digital data is eventually delivered to the user application.

Touch screen 110 displays text/images, etc, defined by the display signals received from touch screen controller 560. Thus, touch screen 110 may display a GUI generated by an application executed by CPU 540. Touch screen 110 generates touch signals in response to touch operations using finger(s) or stylus, etc., with respect to a corresponding portion (for example a visual element) of touch screen 110. Touch screen controller 560 and touch screen 110 may be implemented in a known way.

In this document, the term “computer program product” is used to generally refer to removable storage unit or hard disk installed in hard drive. These computer program products are means for providing software to digital processing system 500. CPU 510 may retrieve the software instructions, and execute the instructions to provide various features of the present disclosure described above.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 7. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating selection of elements displayed on a touch screen contained in a touch system, the method comprising:
sending a plurality of elements for display on said touch screen;
receiving a point of tap in response to a user having touched a touch area on said touch screen, said touch area covering multiple ones of said plurality of elements;
forming a zone with said point of tap as the centre of said zone;
identifying a set of elements of said plurality of elements, covered at least in part by said zone on said touch screen;
computing a respective distance from each of said set of elements to said point of tap; and
determining a first element of said set of elements having the shortest computed distance as the element selected by said user in said touch area on said touch screen.

2. The method of claim 1, wherein each element is sent for display on a respective area on said touch screen,
wherein said identifying includes a first element in said set of elements only if the respective area of said first element overlaps with at least a portion of said zone.

3. The method of claim 2, wherein said respective distance is computed from a closest boundary of the element from said point of tap.

4. The method of claim 1, wherein said first element is included in said set of elements only if said area of said first element is entirely included in said zone.

5. The method of claim 4, wherein said at least some of said plurality of elements are densely populated on said touch screen such that a touch area covers multiple ones of the displayed elements.

6. The method of claim 5, wherein said respective distance is computed between a centre of the corresponding element and said point of tap.

7. The method of claim 1, wherein said sending, said receiving, said forming, said identifying, said computing and said determining are all performed within said touch system.

8. A non-transitory machine readable medium storing one or more sequences of instructions for causing a touch system to facilitate selection of elements displayed on a touch screen contained in said touch system, wherein execution of said one or more sequences of instructions by one or more processors contained in said touch system causes said touch system to perform the actions of:
sending a plurality of elements for display on said touch screen;
receiving a point of tap in response to a user having touched a touch area on said touch screen, said touch area covering multiple ones of said plurality of elements;
forming a zone with said point of tap as the centre of said zone;
identifying a set of elements of said plurality of elements, covered at least in part by said zone on said touch screen;
computing a respective distance from each of said set of elements to said point of tap; and
determining a first element of said set of elements having the shortest computed distance as the element selected by said user in said touch area on said touch screen.

9. The machine readable medium of claim 8 wherein each element is sent for display on a respective area on said touch screen,
wherein said identifying includes a first element in said set of elements only if the respective area of said first element overlaps with at least a portion of said zone.

10. The machine readable medium of claim 9, wherein said respective distance is computed from a closest boundary of the element from said point of tap.

11. The machine readable medium of claim 8 wherein said first element is included in said set of elements only if said area of said first element is entirely included in said zone.

12. The machine readable medium of claim 11, wherein said at least some of said plurality of elements are densely populated on said touch screen such that a touch area covers multiple ones of the displayed elements.

13. The machine readable medium of claim 12, wherein said respective distance is computed between a centre of the corresponding element and said point of tap.

14. The machine readable medium of claim 8, wherein said sending, said receiving, said forming, said identifying, said computing and said determining are all performed within said touch system.

15. A digital processing system comprising:
a touch screen;
a memory to store instructions;
a processing unit to retrieve instructions from said memory an execute the retrieved instructions, wherein execution of said retrieved instructions causes said digital processing system to perform the actions of:
receiving a point of tap in response to a user having touched a touch area on said touch screen, said touch area covering multiple ones of said plurality of elements;
forming a zone with said point of tap as the centre of said zone;
identifying a set of elements of said plurality of elements, covered at least in part by said zone on said touch screen;
computing a respective distance from each of said set of elements to said point of tap; and
determining a first element of said set of elements having the shortest computed distance as the element selected by said user in said touch area on said touch screen.

16. The digital processing system of claim 15, wherein each element is sent for display on a respective area on said touch screen,
wherein said identifying includes a first element in said set of elements only if the respective area of said first element overlaps with at least a portion of said zone.

17. The digital processing system of claim 16 wherein said respective distance is computed from a closest boundary of the element from said point of tap.

18. The digital processing system of claim 15, wherein said first element is included in said set of elements only if said area of said first element is entirely included in said zone.

19. The digital processing system of claim 18, wherein said at least some of said plurality of elements are densely populated on said touch screen such that a touch area covers multiple ones of the displayed elements.

20. The digital processing system of claim 19 wherein said respective distance is computed between a centre of the corresponding element and said point of tap.
